(19) United States
(12) Patent Application Publication
(10) Pub. No.: US 2025/0081140 A1
(43) Pub. Date: Mar. 6, 2025

(54) CONFIDENTIALITY AND PRIVACY PROTECTION OF MESSAGES FROM RESTRICTED DEVICES

(71) Applicant: LENOVO (SINGAPORE) Pte Limited, Singapore (SG)

(72) Inventors: Andreas KUNZ, Ladenburg (DE); Sheeba Backia Mary BASKARAN, Friedrichsdorf (DE)

(21) Appl. No.: 18/819,763

(22) Filed: Aug. 29, 2024

Related U.S. Application Data
(60) Provisional application No. 63/580,177, filed on Sep. 1, 2023.

(51) Int. Cl. H04W 60/04; H04W 12/041; H04W 84/18

(52) U.S. Cl. CPC H04W 60/04; H04W 12/041; H04W 84/18

(57) ABSTRACT

Various aspects of the present disclosure relate to performing confidentiality and/or privacy protection for communications between devices, such as ambient energy-powered devices. In some cases, the IoT devices and/or IoT servers can perform key generation using secret parameters that are only known to the devices/servers as input into a hash function. For example, the IoT server and IoT device can utilize a device identifier as a secret parameter, which is input, along with a nonce, into hash operations or functions to generate security keys (e.g., a key K). In some cases, key generation can include time information or other similar information to ensure freshness of the security K during generation.

### CROSS REFERENCE TO RELATED APPLICATIONS

This application claims priority to U.S. Provisional Patent Application No. 63/580,177, filed on Sep. 1, 2023, entitled CONFIDENTIALITY AND PRIVACY PROTECTION OF MESSAGES FROM RESTRICTED DEVICES, which is hereby incorporated by reference in its entirety.

### TECHNICAL FIELD

The present disclosure relates to wireless communications, and more specifically to the protection (e.g., confidentiality and/or privacy) of messages between devices.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The present disclosure relates to methods, apparatuses, and systems that support performing confidentiality and/or privacy protection for communications between devices, such as ambient energy-powered devices.

Some implementations of the methods and apparatuses described herein may further include a network entity for wireless communication, comprising at least one memory, and at least one processor coupled with the at least one memory and configured to cause the network entity to select a UE that is unregistered with the network entity, generate a nonce based on a device identifier for the selected UE and also generate a temporary identifier that is based on the nonce and the device identifier, and transmit a registration request message that includes the nonce and the temporary identifier to the selected UE for registering with the network entity.

In some implementations of the methods and apparatuses described herein, the at least one processor is further configured to cause the network entity to receive, from the selected UE, a response message that includes the temporary identifier and an indication of a match of the temporary identifier as received from the network entity and a corresponding temporary identifier as stored in the selected UE.

In some implementations of the methods and apparatuses described herein, the at least one processor is further configured to cause the network entity to register the selected UE in response to the match of the temporary identifier generated by the network entity and the corresponding temporary identifier stored by the selected UE.

In some implementations of the methods and apparatuses described herein, the at least one processor is further configured to cause the network entity to generate a hash based on the nonce and the device identifier and truncate the hash to generate a security key K for encrypting the device identifier to derive the temporary identifier, wherein the temporary identifier corresponds to remaining bits of the hash.

In some implementations of the methods and apparatuses described herein, the processor is further configured to cause the network entity to receive, from the selected UE, a response message that includes the temporary identifier, an indication of a match of the temporary identifier as received from the network entity and a corresponding temporary identifier as stored in the selected UE, and one or more parameters encrypted by the security key K and decrypt the one or more parameters using the security key K.

In some implementations of the methods and apparatuses described herein, the network entity is an Internet of Things (IoT) server and the UE is an ambient energy powered IoT device.

In some implementations of the methods and apparatuses described herein, the at least one processor is configured to cause the network entity to generate the hash using the nonce and the device identifier.

In some implementations of the methods and apparatuses described herein, the at least one processor is configured to cause the network entity to generate the hash using the nonce, the device identifier, a length of the nonce, and a root key.

In some implementations of the methods and apparatuses described herein, the at least one processor is configured to cause the network entity to generate the hash as an output of a hash function using one or more parameters, including the device identifier, a random number, or time information.

In some implementations of the methods and apparatuses described herein, the nonce is a truncated output of the hash function.

In some implementations of the methods and apparatuses described herein, the at least one processor is configured to cause the network entity to generate the hash using based on one or more parameters, including a random number, time information, a timer, a counter, or an additional nonce.

In some implementations of the methods and apparatuses described herein, the hash includes most significant bits that represent the temporary identifier and least significant bits that represent a security key K.

In some implementations of the methods and apparatuses described herein, the hash includes least significant bits that represent the temporary identifier, and most significant bits that represent a security key K.

Some implementations of the methods and apparatuses described herein may further include a UE for wireless communication, comprising at least one memory, and at least one processor coupled with the at least one memory and configured to cause the UE to generate a temporary identifier that is based on a nonce and a device identifier of the UE and transmit a registration request message that includes the nonce and the temporary identifier to a network entity.

In some implementations of the methods and apparatuses described herein, the at least one processor is further configured to cause the UE to receive, from the network entity, a response message that includes the temporary identifier.

In some implementations of the methods and apparatuses described herein, the temporary identifier is a truncated portion of an output hash based on the nonce and the device identifier.

In some implementations of the methods and apparatuses described herein, the at least one processor is configured to cause the UE to generate a security key K for encrypting the device identifier to derive the temporary identifier.

Some implementations of the methods and apparatuses described herein may further include a processor for wireless communication, comprising at least one controller coupled with at least one memory and configured to cause the processor to receive a registration request from a network server that includes a nonce and a temporary identifier, compare the temporary identifier received via the registration request and the generated temporary identifier, and, when the comparison indicates a match of the temporary identifier received via the registration request and the generated temporary identifier, transmit a response message to the network server that indicates the match of the temporary identifier and the generated temporary identifier.

In some implementations of the methods and apparatuses described herein, the at least one controller is further configured to cause the processor to generate an output hash using a device identifier associated with the processor and the nonce from the registration request and generate a temporary identifier using the output hash of the device identifier associated with the processor and the nonce from the registration request.

Some implementations of the methods and apparatuses described herein may further include a method performed by an IoT device, the method comprising receiving a registration request from a network server that includes a nonce and a temporary identifier, generating an output hash using a device identifier for the IoT device and the nonce from the registration request, generating a temporary identifier using the device identifier for the IoT device and the nonce from the registration request, comparing the temporary identifier received via the registration request and the generated temporary identifier, and, when the comparison indicates a match of the temporary identifier received via the registration request and the generated temporary identifier, transmitting a response message to the network server that indicates the match of the temporary identifier and the generated temporary identifier.

### BRIEF DESCRIPTION OF THE DRAWINGS

FIG. 1 illustrates an example of a wireless communications system in accordance with aspects of the present disclosure.

FIG. 2 illustrates an example of messaging between an IoT server and an ambient-powered IoT device in accordance with aspects of the present disclosure.

FIG. 3 illustrates an example server-initiated messaging flow between an IoT server and an IoT device in accordance with aspects of the present disclosure.

FIG. 4 illustrates an example representation of an output hash in accordance with aspects of the present disclosure.

FIG. 5 illustrates an example device-initiated messaging flow between an IoT server and an IoT device in accordance with aspects of the present disclosure.

FIG. 6 illustrates an example of a user equipment (UE) in accordance with aspects of the present disclosure.

FIG. 7 illustrates an example of a processor in accordance with aspects of the present disclosure.

FIG. 8 illustrates an example of a network equipment (NE) in accordance with aspects of the present disclosure.

FIG. 9 illustrates a flowchart of a method performed by a UE in accordance with aspects of the present disclosure.

FIG. 10 illustrates a flowchart of a method performed by a NE in accordance with aspects of the present disclosure.

FIG. 11 illustrates a flowchart of a method performed by a UE in accordance with aspects of the present disclosure.

### DETAILED DESCRIPTION

Ambient power-enabled devices, such as ambient power-enabled Internet of Things (IoT) devices, include battery-less devices that have limited storage capabilities (e.g., they store a limited amount of energy using capacitors) or other capability restrictions. These restricted devices may store energy by harvesting energy from the environment of the IoT device, such as via radio waves, light, heat, motion, and other energy/power sources available to the IoT device. Example restricted devices include location tags or stickers, such as tag attached to objects that enable a network server to track locations of the objects. Thus, the network server may be associated with many restricted devices (e.g., hundreds or thousands) for a time period and/or certain deployment.

Such IoT devices may have a low complexity (e.g., low power consumption and few capabilities) to ensure a long life (e.g., 10 plus years) and usefulness. Unlike other IoT devices, such as those defined by 3GPP (3^{rd} Generation Partnership Project), ambient power-enabled devices may not include a USIM (universal subscriber identity module), and thus may lack components that can apply security to communications to/from the devices. Example ambient power-enabled IoT devices may include tags that track items across a supply chain or e-commerce platform.

Lacking a USIM or other similar component, these IoT devices cannot employ typical confidentiality or privacy protection to its communications, because such techniques are computationally intense and may utilize all or much of any harvested energy just to perform the protection. Thus, ambient power-enabled IoT devices should employ other techniques that balance the resources for performing computations with a desired level of security.

In some embodiments, the IoT devices and/or IoT servers can perform key generation using secret parameters that are only known to the devices/servers as input into a hash function. For example, the IoT server and IoT device can utilize a device identifier as a secret parameter, which is input, along with a nonce, into hash operations or functions to generate security keys (e.g., a key K). In some cases, key generation can include time information or other similar information to ensure freshness of the security K during generation.

Such operations have a low complexity, but a suitable level of protection, and thus can be useful for IoT devices and other ambient power-enabled devices when sending confidentiality and/or privacy protected messages, such as during registration procedures.

Aspects of the present disclosure are described in the context of a wireless communications system.

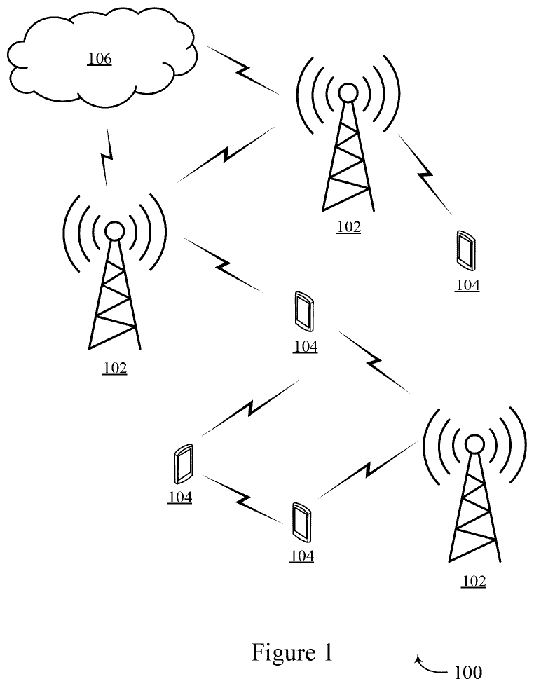

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

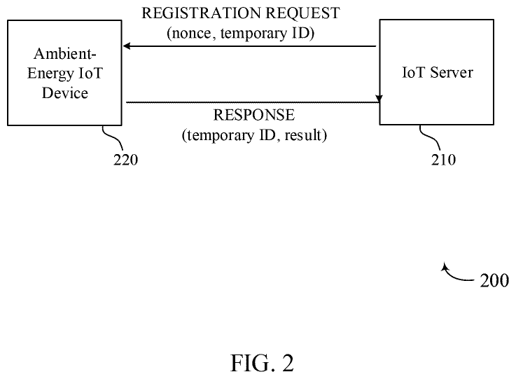

As described herein, the technology can utilize secret parameters to ensure confidentiality and/or privacy protection between an IoT device (or devices), such as a restricted device, and an IoT server. FIG. 2 illustrates an example of messaging 200 between an IoT server 210 and an ambient-powered IoT device 220 in accordance with aspects of the present disclosure.

The IoT server 210 sends a registration request message to the IoT device 220. For example, the registration request message can include an initial registration request to register the IoT device 220 with the IoT server 210. The IoT device 220, in response to the request message, can perform a confidentiality and/or privacy protect operation, as described herein, and transmit a response message back to the IoT server 210 that indicates a result of the operation, such as a successful registration to the IoT server 210. In some cases, the IoT device 220 may initiate a registration procedure with the IoT server 210 and transmit the registration request message to the IoT server 210.

As described herein, either the IoT device 220 or the IoT server 210 may utilize a secret parameter when generating a security key (e.g., a key K) to be used when exchanging messages during a registration between the IoT device 220 and the IoT server 210. For example, the IoT server 210 may utilize a device identifier for the IoT device 220 as the secret parameter when the device identifier is unique to all devices associated with the IoT server 210.

In some cases, the device identifier can be known to the IoT server 210, such as via a configuration during provisioning of the IoT server 210, the IoT device 220, and other similar IoT devices. For example, a warehouse management platform can receive device IDs associated with goods or objects delivered to the warehouse (e.g., via scanning barcodes), where the device IDs are related to IoT devices tagged or otherwise attached to the goods or objects.

Thus, a key generation operation or key generator may receive the device identifier and a nonce as input and perform a hash function or key derivation function (KDF) to generate a security key K as an output hash of the performed function. In some cases, the hash function may generate the output hash based on the device identifier, nonce, and a length of the nonce (e.g., 0×04) and/or generate the output hash as a truncated hash that depends on an output length of the hashing algorithm or function (e.g., MD2, MD4, SHA1, SHA224, and so on).

To ensure a security key K is freshly generated, the nonce can include or be based on time information, such as time information received via messages broadcast to IoT devices from the IoT server 220. Thus, in some embodiments, the IoT server 210 may create the nonce as an output hash, optionally concatenated, of the device identifier, a random number, and time information.

In some cases, the key generation operation may utilize a KDF to generate the security key, or output encryption key, K. The KDF may receive as input the nonce (e.g., the output hash) and, optionally, the length of the nonce, and may receive the device identifier as an input key, such as an initial root key (e.g., a password) that is pre-configured to the IoT device 220 (and shared with the IoT server 210).

Thus, the security key K may be a truncated output hash of the most significant bits or the least significant bits (e.g., 32 bits, 48, bits, 64 bits, and so on). The length of the security key K may be based on the encryption algorithm, a message length, and/or memory capabilities of the IoT device 220. In some cases, the various functions, or algorithms (e.g., the encryption algorithm, the hashing algorithm or function), the key length, and other parameters described herein may be pre-configured to the IoT device 220 and IoT server 210.

In some cases, the IoT server 210, when addressing one or more IoT devices (e.g., the IoT device 220), may use temporary device identifiers assigned to the IoT devices for a single use (e.g., during an initial registration). In other cases, the IoT devices may be assigned to categories, locations, or other subsets of devices, to limit the number of devices initially addressed by the IoT server 210 (e.g., the IoT server 210 may only check a subset of devices during an initial registration procedure).

During the addressing of IoT devices, the IoT server 210 may exchange an encrypted device identifier as a temporary identifier with the IoT device 220. Further, when the security key K is based on a truncated output hash, the remaining part of the output hash may be the temporary identifier for the IoT device 220.

In various cases, the IoT device 220 may include other security algorithms for security protection of messages, while utilizing the technology described herein for privacy/confidentiality protection of messages, such as during registration procedures.

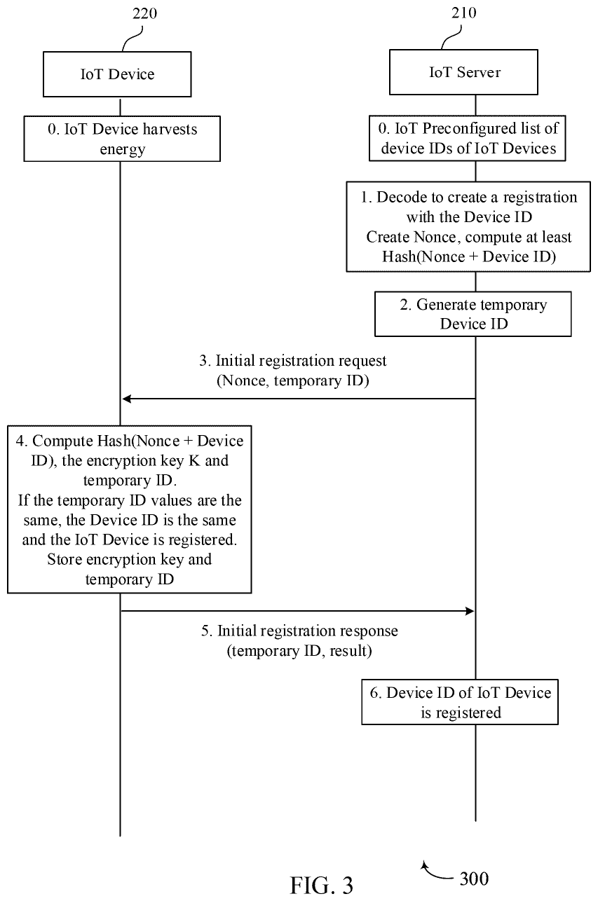

FIG. 3 illustrates an example server-initiated messaging flow 300 between the IoT server 210 and the IoT device 220 in accordance with aspects of the present disclosure. The messaging flow 300 may implement various aspects of the present disclosure described herein. For example, the messaging flow 300 may include the IoT server 210 and the IoT device 220, which may be examples of IoT servers and IoT devices, as described herein. In the following description of the messaging flow 300, the operations between the IoT server 210 and the IoT device 220 may be performed in different orders or at different times. Some operations may also be omitted, or other operations may be added. Although the IoT server 210 and the IoT device 220 are shown performing the operations of the messaging flow 300, some aspects of some operations may also be performed by other entities of the messaging flow 300 or by entities that are not shown in the messaging flow 300, or any combination thereof.

First, in step 0 (e.g., before initiation the procedure), the IoT server 210 stores or is aware of all associated IoT devices, including the IoT device 220, via stored device identifiers. The IoT device 220, to perform operations, may harvest energy, as described herein.

In step 1, the IoT server 210 begins to set up a security association with the IoT Device 220, which is identified with a specific device ID. The IoT server 210 generates a nonce, which may be a random number, a random string, and so on, having a minimum length to ensure an acceptable level of uniqueness across devices associated with the IoT server 210.

The IoT server 210 generates a hash from a concatenation of the device ID and the nonce, where an Output Hash=Hash(Device ID+Nonce). The output hash may also be based on a length of the nonce and a root key. The generation of the output hash may be a hash function or a KDF, as described herein.

In some cases, the IoT server 210 may utilize the full output hash as the encryption Key K. In some cases, the IoT server 210 may truncate the output hash and use the most significant bits or the least significant bits of as the encryption Key K, where the remaining bits represent a temporary ID for addressing purposes, as described herein. In these cases, the remaining bits may have a sufficient or minimum length that is based on the amount of IoT devices active in a serving area of the IoT server 210 (e.g., the length of the temporary ID may be larger when there is a large number of devices to avoid multiple IoT devices being addressed with the same temporary ID).

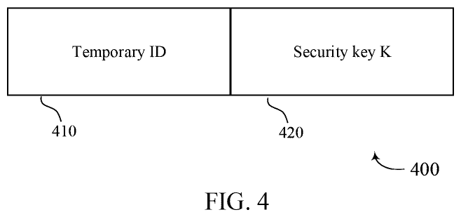

FIG. 4 illustrates an example representation of an output hash 400 in accordance with aspects of the present disclosure. As shown, the output hash 400 is concatenated, with a first portion 410, the most significant bits, representing the temporary identifier, and a second portion 420, the least significant bits, representing the encryption key K. Thus, the output hash 400 is truncated with the least significant bits representing the key K.

In step 2, The IoT server 210 encrypts the device ID with the encryption key K as a temporary identifier and the configured encryption algorithm. Alternatively, the IoT device 220 uses the temporary ID corresponding to a remaining part of the output hash of the encryption key K.

In step 3, the IoT server 210 transmits an initial registration request message to the IoT device 220. The request includes or contains the nonce and the temporary ID. As described herein, to limit the amount of IoT devices that receive the request (and perform a hash operation), the device profile in the IoT server 210 may store initial temporary device IDs for one time use at a time of initial registration for all devices as device profile information and/or may broadcast the request to a subset of IoT devices, as described herein.

In step 4, the IoT device 220 (and possibly other device) receives the initial registration request from the IoT server 210. The IoT device 220 computes or otherwise determines the encryption key K and temporary ID as described herein, such as via a hash of the device ID and the nonce (and, optionally, the length of the nonce and/or a root key).

The IoT device 220 computes or otherwise determines the temporary ID. For example, the IoT device 220 encrypts the device ID with the key K or uses the temporary identifier when the key K is a truncated hash. The IoT device 220 compares the determined temporary ID with the received temporary ID, and when the compared temporary IDs match, the IoT device 220 confirms determines it was successfully targeted by the IoT server 210 and can send a result of the comparison to the IoT server 210.

As described herein, the IoT server 210 may broadcast the initial registration request to multiple devices, such as when there is no direct addressing of the IoT device 220. Each of the devices (e.g., a subset of devices) may perform the process described in step 4 or may skip the process if already registered with the IoT server 210.

In step 5, the IoT device 220 transmits an initial registration response message, which includes or contains a result of the comparison and the determined temporary ID, to the IoT server 210. However, when the temporary identifiers do not match, the IoT device 220 may not send a response message. At this point, the IoT device 220 is registered with the IoT server 210 and may refrain from performing additional comparisons for a certain time period (e.g., tracked by a registration timer).

In some cases, the IoT device 220 may transmit other or additional information to the IoT server 210 via the response message, such as device capabilities, security capabilities, and so on. The IoT device 220 may encrypt the additional information with the key K.

In step 6, the IoT server 210 receives the response message. The IoT server 210 stores or otherwise marks the IoT device 220 as being registered. Further, if the response message includes information indicating security capabilities, the IoT server 210 may transmit a second request message to set up a security association (e.g., use of a stronger key) to exchange information using confidentiality protection.

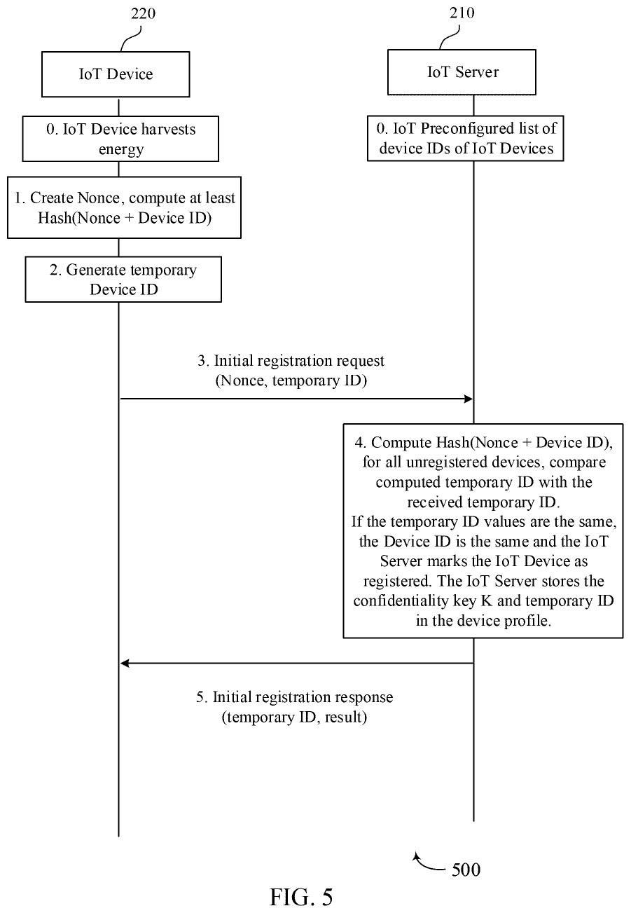

As described herein, in some embodiments, the IoT device 220 may initiate the registration procedure with the IoT server 210. FIG. 5 illustrates an example device-initiated messaging flow 500 between the IoT server 210 and the IoT device 220 in accordance with aspects of the present disclosure. The messaging flow 500 may implement various aspects of the present disclosure described herein. For example, the messaging flow 500 may include the IoT server 210 and the IoT device 220, which may be examples of IoT servers and loT devices, as described herein. In the following description of the messaging flow 500, the operations between the IoT server 210 and the IoT device 220 may be performed in different orders or at different times. Some operations may also be omitted, or other operations may be added. Although the IoT server 210 and the IoT device 220 are shown performing the operations of the messaging flow 500, some aspects of some operations may also be performed by other entities of the messaging flow 500 or by entities that are not shown in the messaging flow 500, or any combination thereof.

Messaging flow 500 may be similar in aspects to messaging flow 300. For example, in step 0 (e.g., before initiation the procedure), the IoT server 210 stores or is aware of all associated IoT devices, including the IoT device 220, via stored device identifiers. The IoT device 220, to perform operations, may harvest energy, as described herein.

In step 1, the IoT device 220 initiates setup procedure to establish a security association with the IoT server 210. The IoT device 220 generates a nonce, as described herein. Using the nonce, the IoT device 220 generates a hash from a concatenation of its associated device identifier and the nonce (as described herein), where the hash is generated as Output Hash=Hash(Device ID+Nonce).

In step 2, the IoT device 220 encrypts its associated device identifier with the encryption key K and the configured encryption algorithm, which generates a temporary identifier. In some cases, the IoT device 220 uses the temporary ID corresponding to a remaining part of the output hash of the encryption key K, when the key K is a truncated hash.

In step 3, the IoT device 220 transmits an initial registration request message to the IoT server 210. The request includes or contains the nonce and the temporary ID. As described herein, the request message may include an initial temporary device identifier via which the IoT server can identify the IoT device 220.

In some cases, the IoT device 220 may transmit other or additional information to the IoT server 210 via the request message, such as device capabilities, security capabilities, and so on. The IoT device 220 may encrypt the additional information with the key K.

In step 4, the IoT server 210 receives the initial registration request from the IoT server 210. The IoT device 220 computes or otherwise determines the encryption key K and temporary ID as described herein, such as via a hash of the device ID and the nonce (and, optionally, the length of the nonce and/or a root key).

For the device ID, the IoT server 210 selects a corresponding profile to the temporary device ID (when available), selects all unregistered devices belonging to an indicated category (e.g., one by one), or selects all unregistered devices.

The IoT device 220 computes or otherwise determines the temporary ID. For example, the IoT device 220 encrypts the device ID with the key K or uses the temporary identifier when the key K is a truncated hash. The IoT device 220 compares the determined temporary ID with the received temporary ID, and when the compared temporary IDs match, the IoT device 220 confirms determines it was successfully targeted by the IoT server 210 and can send a result of the comparison to the IoT server 210.

When several device IDs are part of a category, or when all device IDs are possible devices, the IoT server 210 repeats the computation until the computed temporary ID corresponds to the received temporary ID. The IoT device associated with a match of temporary IDs is then registered to the IoT server 210.

In step 5, the IoT server 210 transmits an initial registration response message with a result of the comparison of the temporary IDs, as well as the temporary ID. Based on information received via the request message, the IoT server 210 may transmits additional information to set up a security association (e.g., use of a stronger key) to exchange information using confidentiality protection.

In various embodiments, a sender (e.g., the IoT device 220 or the IoT server 210) may initiate a key refresh at any time, such as by computing a new nonce, a new temporary ID2, and a new encryption key K2. The sender transmits the new nonce to the receiver (e.g., the other of the IoT device 220 or the IoT server 210), encrypted with the old encryption Key K, using the old temporary ID to address the receiver. The receiver decrypts the nonce2 and computes the new temporary ID2 and encryption key K2, using the decrypted nonce2. The receiver then sends the response message using the new temporary ID2 and potential message encryption with the new encryption key K2.

In some cases, the sender and/or the receiver may use additional input parameters, and, optionally, lengths of the parameters, as input to the hash function or the KDF. These parameters may include timers, counters, additional nonces, random numbers, device specific parameters, and so on.

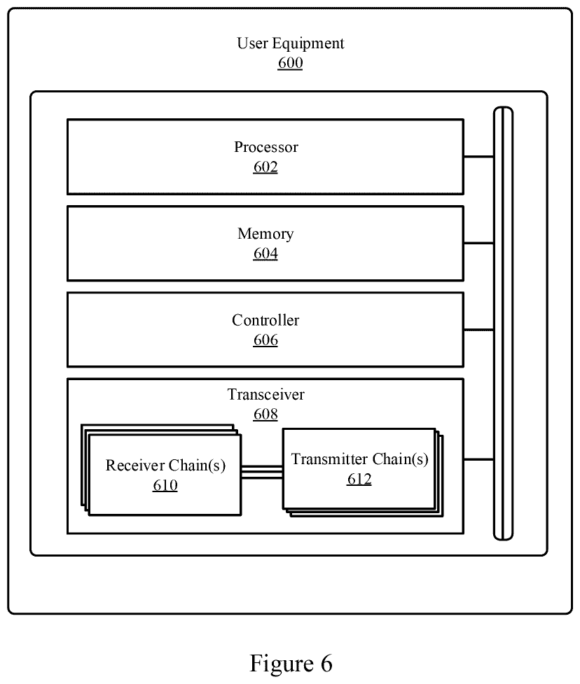

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions when executed by the processor 602 cause the UE 600 to perform various functions described herein. The code may be stored in a non-transitory computer-readable medium such the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the UE 600 to perform one or more of the functions described herein (e.g., executing, by the processor 602, instructions stored in the memory 604). For example, the processor 602 may support wireless communication at the UE 600 in accordance with examples as disclosed herein. The UE 600 may be configured to support a means for generating a temporary identifier that is based on a nonce and a device identifier for the UE and transmitting a registration request message that includes the nonce and the temporary identifier to a network entity.

The UE 600 may be also configured to support a means for receiving a registration request from a network server that includes a nonce and a temporary identifier, comparing the temporary identifier received via the registration request and the generated temporary identifier, and when the comparison indicates a match of the temporary identifier received via the registration request and the generated temporary identifier, transmitting a response message to the network server that indicates the match of the temporary identifier and the generated temporary identifier.

The controller 606 may manage input and output signals for the UE 600. The controller 606 may also manage peripherals not integrated into the UE 600. In some implementations, the controller 606 may utilize an operating system such as iOS®, ANDROID®, WINDOWS®, or other operating systems. In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas for receive the signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the processing the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

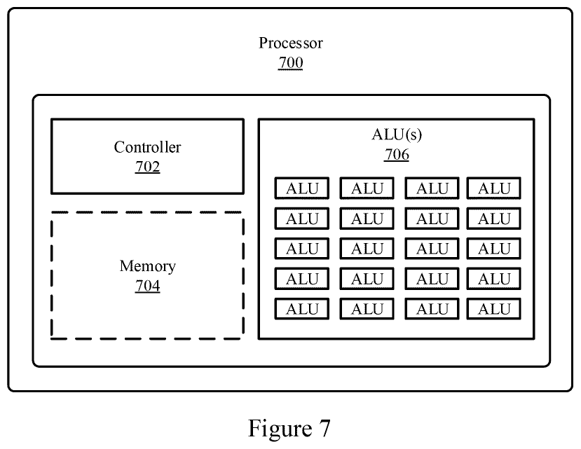

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory address of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, arithmetic logic units (ALUs), and other functional units of the processor 700.

The memory 704 may include one or more caches (e.g., memory local to or included in the processor 700 or other memory, such RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, the controller 702, and the memory 704 may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may support wireless communication in accordance with examples as disclosed herein. The processor 700 may be configured to or operable to support a means for generating an output hash based on a nonce and a device identifier for a UE, generating a temporary identifier that is based on the nonce and the device identifier, and transmitting a registration request message that includes the nonce and the temporary identifier to a network entity.

The processor 700 may be also configured to support a means for receiving a registration request from a network server that includes a nonce and a temporary identifier, comparing the temporary identifier received via the registration request and the generated temporary identifier, and when the comparison indicates a match of the temporary identifier received via the registration request and the generated temporary identifier, transmitting a response message to the network server that indicates the match of the temporary identifier and the generated temporary identifier

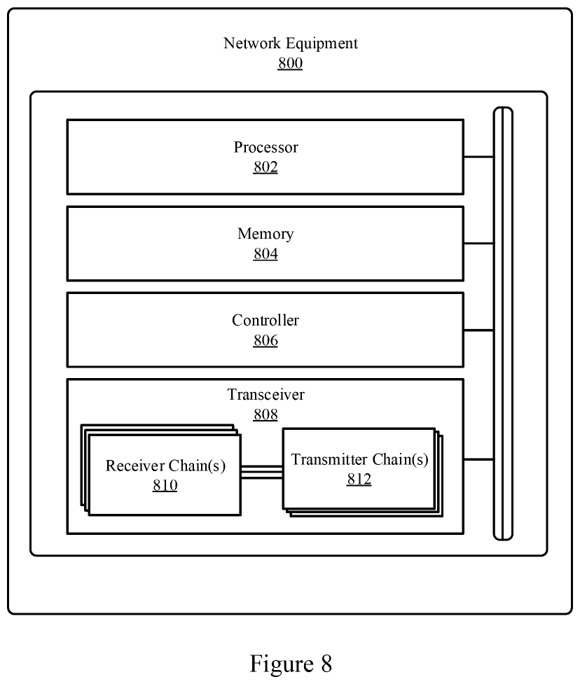

FIG. 8 illustrates an example of a NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804). For example, the processor 802 may support wireless communication at the NE 800 in accordance with examples as disclosed herein. The NE 800 may be configured to support a means for selecting a UE that is unregistered with the network entity, generating a nonce based on a device identifier for the selected UE and also generate a temporary identifier that is based the nonce and the device identifier, and transmitting a registration request message that includes the nonce and the temporary identifier to the selected UE for registering with the network entity.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas for receive the signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the processing the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

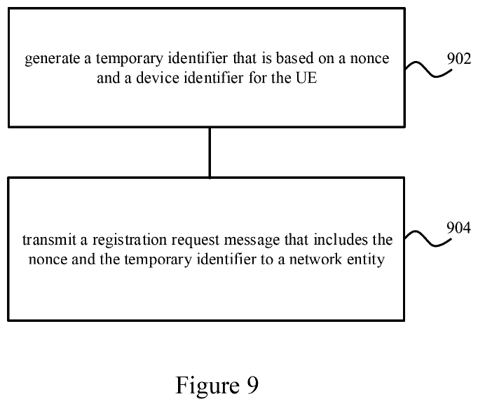

FIG. 9 illustrates a flowchart of a method in accordance with aspects of the present disclosure. The operations of the method may be implemented by a UE as described herein. In some implementations, the UE may execute a set of instructions to control the function elements of the UE to perform the described functions.

At 902, the method may include generating a temporary identifier that is based on a nonce and a device identifier of the UE. The operations of 902 may be performed in accordance with examples as described herein. In some implementations, aspects of the operations of 902 may be performed by a UE as described with reference to FIG. 6.

At 904, the method may include transmitting a registration request message that includes the nonce and the temporary identifier to a network entity. The operations of 904 may be performed in accordance with examples as described herein. In some implementations, aspects of the operations of 904 may be performed a UE as described with reference to FIG. 6.

It should be noted that the method described herein describes a possible implementation, and that the operations and the steps may be rearranged or otherwise modified and that other implementations are possible.

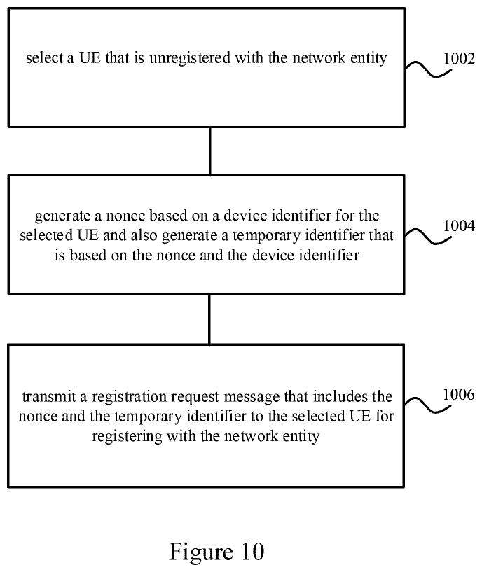

FIG. 10 illustrates a flowchart of a method in accordance with aspects of the present disclosure. The operations of the method may be implemented by a NE as described herein. In some implementations, the NE may execute a set of instructions to control the function elements of the NE to perform the described functions.

At 1002, the method may include selecting a UE that is unregistered with the network entity. The operations of 1002 may be performed in accordance with examples as described herein. In some implementations, aspects of the operations of 1002 may be performed by a NE as described with reference to FIG. 8.

At 1004, the method may include generating a nonce based on a device identifier for the selected UE and also generate a temporary identifier that is based on the nonce and the device identifier. The operations of 1004 may be performed in accordance with examples as described herein. In some implementations, aspects of the operations of 1004 may be performed by a NE as described with reference to FIG. 8.

At 1006, the method may include transmitting a registration request message that includes the nonce and the temporary identifier to the selected UE for registering with the network entity. The operations of 1006 may be performed in accordance with examples as described herein. In some implementations, aspects of the operations of 1006 may be performed by a NE as described with reference to FIG. 8.

It should be noted that the method described herein describes a possible implementation, and that the operations and the steps may be rearranged or otherwise modified and that other implementations are possible.

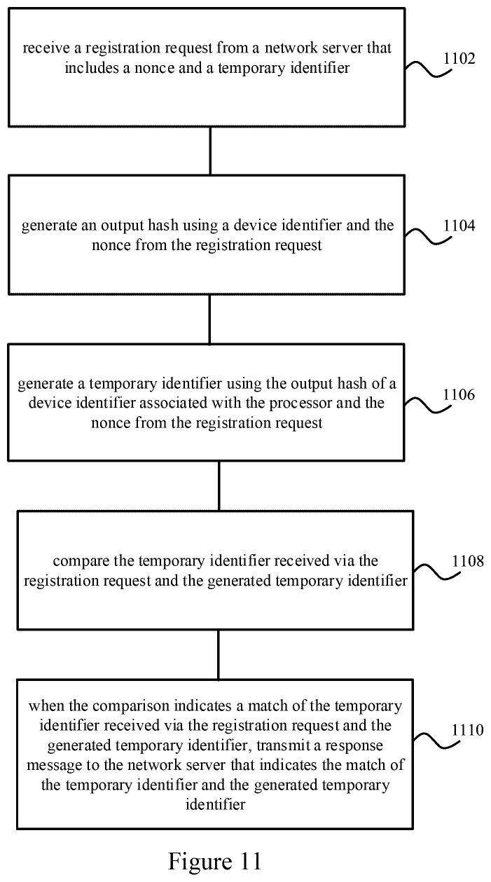

FIG. 11 illustrates a flowchart of a method in accordance with aspects of the present disclosure. The operations of the method may be implemented by a UE as described herein. In some implementations, the UE may execute a set of instructions to control the function elements of the UE to perform the described functions.

At 1102, the method may include receiving a registration request from a network server that includes a nonce and a temporary identifier. The operations of 1102 may be performed in accordance with examples as described herein. In some implementations, aspects of the operations of 1102 may be performed by a UE as described with reference to FIG. 6.

At 1104, the method may include generating an output hash using a device identifier associated with the processor and the nonce from the registration request. The operations of 1104 may be performed in accordance with examples as described herein. In some implementations, aspects of the operations of 1104 may be performed by a UE as described with reference to FIG. 6.

At 1106, the method may include generating a temporary identifier using the output hash of a device identifier associated with the processor and the nonce from the registration request. The operations of 1106 may be performed in accordance with examples as described herein. In some implementations, aspects of the operations of 1106 may be performed by a UE as described with reference to FIG. 6.

At 1108, the method may include comparing the temporary identifier received via the registration request and the generated temporary identifier. The operations of 1108 may be performed in accordance with examples as described herein. In some implementations, aspects of the operations of 1108 may be performed by a UE as described with reference to FIG. 6.

At 1110, the method may include, when the comparison indicates a match of the temporary identifier received via the registration request and the generated temporary identifier, transmitting a response message to the network server that indicates the match of the temporary identifier and the generated temporary identifier. The operations of 1110 may be performed in accordance with examples as described herein. In some implementations, aspects of the operations of 1110 may be performed by a UE as described with reference to FIG. 6.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity for wireless communication, comprising:
at least one memory; and
at least one processor coupled with the at least one memory and configured to cause the network entity to:
select a user equipment (UE) that is unregistered with the network entity;
generate a nonce based on a device identifier for the selected UE and also generate a temporary identifier that is based on the nonce and the device identifier; and
transmit a registration request message that includes the nonce and the temporary identifier to the selected UE for registering with the network entity.

2. The network entity of claim 1, wherein the at least one processor is further configured to cause the network entity to:
receive, from the selected UE, a response message that includes the temporary identifier and an indication of a match of the temporary identifier as received from the network entity and a corresponding temporary identifier as stored in the selected UE.

3. The network entity of claim 2, wherein the at least one processor is further configured to cause the network entity to:
register the selected UE in response to the match of the temporary identifier generated by the network entity and the corresponding temporary identifier stored by the selected UE.

4. The network entity of claim 1, wherein the at least one processor is further configured to cause the network entity to:
generate a hash based on the nonce and the device identifier; and
truncate the hash to generate a security key K for encrypting the device identifier to derive the temporary identifier,
wherein the temporary identifier corresponds to remaining bits of the hash.

5. The network entity of claim 4, wherein the at least one processor is further configured to cause the network entity to:
receive, from the selected UE, a response message that includes the temporary identifier, an indication of a match of the temporary identifier as received from the network entity and a corresponding temporary identifier as stored in the selected UE, and one or more parameters encrypted by the security key K; and
decrypt the one or more parameters using the security key K.

6. The network entity of claim 1, wherein the network entity is an Internet of Things (IoT) server and the UE is an ambient energy powered IoT device.

7. The network entity of claim 1, wherein the at least one processor is configured to cause the network entity to generate the hash using the nonce and the device identifier.

8. The network entity of claim 1, wherein the at least one processor is configured to cause the network entity to generate the hash using the nonce, the device identifier, a length of the nonce, and a root key.

9. The network entity of claim 8, wherein the at least one processor is configured to cause the network entity to generate the hash as an output of a hash function using one or more parameters, including the device identifier, a random number, or time information.

10. The network entity of claim 9, wherein the nonce is a truncated output of the hash function.

11. The network entity of claim 8, wherein the at least one processor is configured to cause the network entity to generate the hash using based on one or more parameters, including a random number, time information, a timer, a counter, or an additional nonce.

12. The network entity of claim 1, wherein the hash includes:
most significant bits that represent the temporary identifier; and
least significant bits that represent a security key K.

13. The network entity of claim 1, wherein the hash includes:
least significant bits that represent the temporary identifier; and
most significant bits that represent a security key K.

14. A user equipment (UE) for wireless communication, comprising:
at least one memory; and
at least one processor coupled with the at least one memory and configured to cause the UE to:
generate a temporary identifier that is based on a nonce and a device identifier of the UE; and
transmit a registration request message that includes the nonce and the temporary identifier to a network entity.

15. The UE of claim 14, wherein the at least one processor is further configured to cause the UE to:
receive, from the network entity, a response message that includes the temporary identifier.

16. The UE of claim 14, wherein the temporary identifier is a truncated portion of an output hash based on the nonce and the device identifier.

17. The UE of claim 14, wherein the at least one processor is configured to cause the UE to generate a security key K for encrypting the device identifier to derive the temporary identifier.

18. A processor for wireless communication, comprising:
at least one controller coupled with at least one memory and configured to cause the processor to:
receive a registration request from a network server that includes a nonce and a temporary identifier;
compare the temporary identifier received via the registration request and the generated temporary identifier; and
when the comparison indicates a match of the temporary identifier received via the registration request and the generated temporary identifier, transmit a response message to the network server that indicates the match of the temporary identifier and the generated temporary identifier.

19. The processor of claim 18, wherein the at least one controller is further configured to cause the processor to:
generate an output hash using a device identifier associated with the processor and the nonce from the registration request; and
generate a temporary identifier using the output hash of the device identifier associated with the processor and the nonce from the registration request.

20. A method performed by an IoT (Internet of Things) device, the method comprising:
receiving a registration request from a network server that includes a nonce and a temporary identifier;
generating an output hash using a device identifier for the IoT device and the nonce from the registration request;
generating a temporary identifier using the device identifier for the IoT device and the nonce from the registration request;
comparing the temporary identifier received via the registration request and the generated temporary identifier; and
when the comparison indicates a match of the temporary identifier received via the registration request and the generated temporary identifier, transmitting a response message to the network server that indicates the match of the temporary identifier and the generated temporary identifier.
